(19) United States
(12) Patent Application Publication
(10) Pub. No.: US 2015/0274589 A1
(43) Pub. Date: Oct. 1, 2015

(54) PROCESS, GRINDING UNIT AND PRODUCTION OF A HYDRAULIC BINDER

(71) Applicant: LAFARGE, Paris (FR)

(72) Inventors: Didier Dumont, Saint Quentin Fallavier (FR); Mylène Martin, Saint Quentin Fallavier (FR)

(73) Assignee: LAFARGE, Paris (FR)

(21) Appl. No.: 14/432,381

(22) PCT Filed: Oct. 25, 2013
(86) PCT No.: PCT/EP2013/072379

§ 371 Date: Mar. 30, 2015

(30) Foreign Application Priority Data
Oct. 26, 2012 (FR) 1260243

(51) Int. Cl. C04B 7/02; B02C 4/02; B02C 23/06

(52) U.S. Cl. CPC C04B 7/02; B02C 23/06; B02C 4/02

(57) ABSTRACT

A compression grinding process of at least one component of a hydraulic binder, include the compression of a bed of material formed by this or these component(s) in a grinding zone, and the addition of oil to the bed of material, via a distribution device located upstream of the inlet to the grinding zone.

The present invention relates to a grinding process and to a grinding unit of at least one component of a hydraulic binder, as well as to a process and installation for production of such a hydraulic binder.

The grinding process of components comprised in a hydraulic binder can generally be carried out in two main manners: using ball mills or compressive mills.

The present invention relates to compressive grinding, wherein the bed of material to be ground is compressed between two grinding surfaces facing each other; this area delimits the grinding zone. Three main types of compressive mills are known.

A first type of compressive mill, called the horizontal compressive mill, comprises a ring and a roller. The roller can roll over a track delimited by the inside surface of the ring. This ring rotates around a horizontal axis, whilst means are used to apply pressure to push the roller against the previously mentioned track, in order to grind the material passing between the roller and the ring.

A second type of compressive mill, called the vertical compressive mill, comprises a table rotating around a vertical axis. This rotating table entrains rollers which rotate around horizontal axes. The material to be ground is fed into the centre of the table, whereby the effect of the centrifugal force pushes the material in a radial direction towards the rollers. The bed of material is compressively ground between the upper surface of the table and the external surface of each roller.

A third type of mill comprises two adjacent rollers, rotating in opposite directions around parallel axes, which are generally horizontal. The material to be ground is fed between the two respective peripheral surfaces of these rollers, these two respective surfaces facing each other. The two respective surfaces are the two grinding surfaces and delimit the grinding zone.

When one or other of these types of mills is in operation, the thickness of the bed of compressed material is reduced during its passage between the grinding zones. When greater fineness is desired, more mechanical pressure has to be exerted on the bed during the grinding operation. Consequently, above a certain pressure on the bed of material, air, which is initially present in the bed of material, escapes. This destabilizes the grinding mill and therefore imposes untimely interruptions of the grinding mill.

According to a first known solution, water is used as a grinding agent. However, this presents a disadvantage, because the addition of water in the hydraulic binder induces premature setting of the hydraulic binder. Consequently, it is necessary to grind more intensively than initially intended.

According to another known solution, admixtures were specifically developed in order to be used as a grinding agent. One major disadvantage of these admixtures is their high cost. Furthermore, they do not ensure satisfactory stability of the bed. Moreover, they are generally used in solution with water. Water has the disadvantages as discussed herein before.

Therefore, the problem the invention seeks to solve is to provide a grinding process of at least one component of a hydraulic binder, which first of all ensures satisfactory stability of the bed of material when the material is ground to high-fineness levels; and said grinding process can be used in a simple and economical manner. Moreover, the solution according to the present invention prevents from using water, and thus prevents from the related drawbacks discussed herein before.

Unexpectedly, the inventors have shown that it is possible to use oil as a stabilizer for compression grinding units to grind at least one component of a hydraulic binder.

With this aim, the invention relates to a compression grinding process of at least one component of a hydraulic binder, said process comprising the compression of a bed of material formed by this or these component(s) in a grinding zone, said process further comprising the addition of oil to the bed of material upstream of the inlet to the grinding zone.

Oil, for example, as used in the process of the invention, belongs to one of the following categories: vegetable, mineral or synthetic.

Vegetable oils are generally extracted from pressed plant seeds. They have the chemical form of triglycerides, which is to say triesters resulting from the condensation of three molecules of fatty acids and one molecule of glycerol. The fatty acids may have one or more carbon-carbon double bonds; the number of double bonds is variable, depending on the plant the oil comes from. The fatty acids and corresponding esters have a reducing capacity, which depends on the number of double bonds and the closeness of these double bonds in the hydrocarbonated chain. This reducing capacity can be measured by the iodine value. The iodine value expresses the degree of unsaturation of a fatty substance: it is the mass of iodine, expressed in grams, which is fixed by 100 g of a fatty substance during an addition reaction.

Mineral oils are obtained by refining crude petroleum products and separating the obtained products. They mainly comprise carbon and hydrogen atoms. The molecules forming these oils typically comprise 15 to 40 carbon atoms. The carbon may be found in one of the following positions in each mineral oil:

paraffin structure with the general formula: CₙH₂ₙ₊₂

naphthenic structure with the general formula: CₙH₂ₙ

aromatic structure with the general formula: CₙH₂ₙ₋₆

Synthetic oils, for example, ester, silicon or graphite types of synthetic oils are lubricants formed from synthesized chemical compounds. Their synthesis uses modified petroleum compounds rather than crude petroleum in its natural state.

This oil is more efficient than water in terms of its agglomerating action on the bed of material. It further solves the problem related to water, which is to say that it does not trigger a premature and untimely setting of the binder.

Therefore, the final binder, obtained at the end of the grinding process according to the invention, due to this addition of oil to the components(s) of the hydraulic binder, comprises a certain fraction of oil. This is advantageous because the presence of oil reduces emissions of dust, in particular when the binder is a cement. This operation of adding oil to the binder therefore produces a double benefit: improved grinding stability and reduced dust releases.

Preferably, the process comprises the addition of a mineral oil to the bed of material. This mineral oil makes it possible to obtain an improved behaviour by lower vibrations.

Preferably, the quantity of oil added to the bed of material is from 0.1 to 1.5%, preferably from 0.5 to 1%, percentage by mass relative to the mass of the components to be ground.

Preferably, the oil is sprayed on the bed of material. This ensures very close contact between the oil and the particles in the bed of material, thus improving the grinding performances.

Preferably, the oil is added in several zones which are positioned on one or more transverse axes relative to the forward-moving direction of the bed of material. This makes it possible to treat a substantial fraction of the particles of the bed of material, and ensure good quality of the grinding.

The invention also relates to a process for production of a hydraulic binder comprising a compression grinding process as defined above. The invention also relates to a hydraulic binder produced according to the process of the invention, said binder comprising 0.1 to 1.5%, preferably 0.5 to 1% by mass of oil, in particular a mineral oil, relative to the mass of binder.

A hydraulic binder is a material which sets and hardens by hydration, for example a cement.

For example, the cement may be:

a Portland cement, which is generally a cement of the CEM I type according to the NF EN 197-1 Standard of February 2001 (see, in particular table 1 on page 12 of the standard);

a pozzolanic cement, which is generally a cement of the CEM IV type according to the NF EN 197-1 Standard of February 2001 (see, in particular table 1 on page 12 of the standard; or

a blended cement, which is generally a cement of the types CEM II, CEM III or CEM V according to the NF EN 197-1 Standard of February 2001 (see, in particular table 1 on page 12 of the standard).

The cement comprises at least one clinker, which is generally the product obtained after burning (clinkerisation) of a mix (raw meal) comprising limestone and for example clay. The clinker may, in particular, be a Portland clinker. For example, a Portland clinker is a clinker as defined in the NF EN 197-1 Standard of February 2001.

Generally, cement, in addition to clinker, comprises calcium sulphate and/or a mineral addition. A Portland clinker is generally co-ground with calcium sulphate to produce cement. Calcium sulphate used according to the present invention includes gypsum (calcium sulphate dihydrate, CaSO₄.2H₂O), hemi-hydrate (CaSO₄.1/2H₂O), anhydrite (anhydrous calcium sulphate, CaSO₄) or mixtures thereof. The gypsum and anhydrite exist in the natural state. Calcium sulphate produced as a by-product of certain industrial processes may also be used.

Mineral additions are, for example, slags (for example as defined in the “cement” NF EN 197-1 Standard of February 2001, paragraph 5.2.2), natural or artificial pozzolans (for example as defined in the “cement” NF EN 197-1 Standard of February 2001, paragraph 5.2.3), fly ash (for example as defined by the “cement” NF EN 197-1 Standard of February 2001, paragraph 5.2.4), calcined shale (for example as defined by the “cement” NF EN 197-1 Standard of February 2001, paragraph 5.2.5), mineral additions with a base of calcium carbonate (for example limestone as defined by the “cement” NF EN 197-1 Standard of February 2001, paragraph 5.2.6), silica fume (for example as defined by the “cement” NF EN 197-1 Standard of February 2001, paragraph 5.2.7), metakaolins, biomass ash or mixtures thereof.

Preferably, the mineral addition comprises pozzolans, slags, fly ash, calcium carbonate or mixtures thereof.

Within the scope of the grinding process according to the present invention, a final hydraulic binder is obtained with a given particle size distribution at the end of the grinding process.

According to an embodiment of the present invention, one or more of the components of the hydraulic binder are ground by the grinding process according to the invention, in order to form this final binder. Preferably, all the components of the hydraulic binder are ground by the grinding process according to the invention. In the case of cement, these components are clinker, gypsum as well as optional mineral additions. In the case of at least two components, they may be co-ground or ground separately. The grinding mode may be chosen taking into account the characteristics of the components (for example humidity, grindability) and the characteristics of the final product.

According to the invention, more than 80% by mass of the component(s) to be ground flow through a sieve of 100 millimetres, preferably through a sieve of 50 millimetres. Moreover, 80% by mass of the component(s) to be ground flow through a sieve of 30 millimetres, preferably through a sieve of 20 millimetres.

The invention also relates to a compression grinding unit of at least one component of a hydraulic binder, comprising:
a mill comprising two complementary grinding units, which delimits a grinding zone, through which passes a bed of material formed by the component(s);
feeding means of the component(s) to be ground into the grinding zone;
evacuation means of the ground component(s) from the grinding zone;
addition means of oil, in particular a mineral oil, located between the feeding means and the grinding zone.

This grinding unit is particularly adapted for implementation of one or other of the characteristics of the grinding process according to the present invention, as described above.

This grinding unit may present at least one of the following characteristics for a horizontal mill or a vertical mill:

horizontally, the distance between the distribution point of oil, which is part of the addition means, and the vertical radius of the roller is from 800 to 1500 millimetres, preferably from 1000 to 1300 millimetres;

the shortest distance between the distribution point and the external surface of the roller is from 50 to 500 millimetres, preferably from 100 to 300 millimetres;

vertically, the distance between the distribution point and the track or the table is less than or equal to 500 millimetres, preferably from 100 to 500 millimetres, more preferably from 200 to 400 millimetres. The invention also relates to a production installation of a hydraulic binder comprising a grinding unit as defined above.

Finally, the invention relates to a use of oil, preferably a mineral oil, as a stabilizer in a compression grinding unit, preferably in a compression grinding unit according to the present invention.

The invention will be described below, with reference to the drawings in the appendix, provided by way of a non-restricting example only, wherein:

FIG. 1 is a front view illustrating a grinding unit according to a first embodiment of the invention;

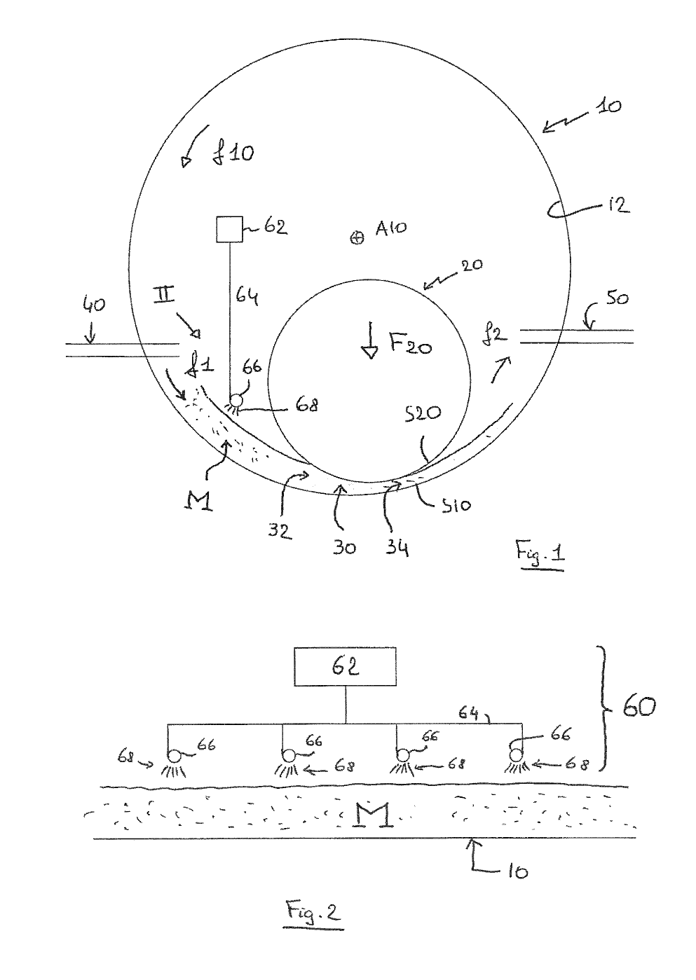

FIG. 2 represents a side view of FIG. 1, according to the arrow II in FIG. 1;

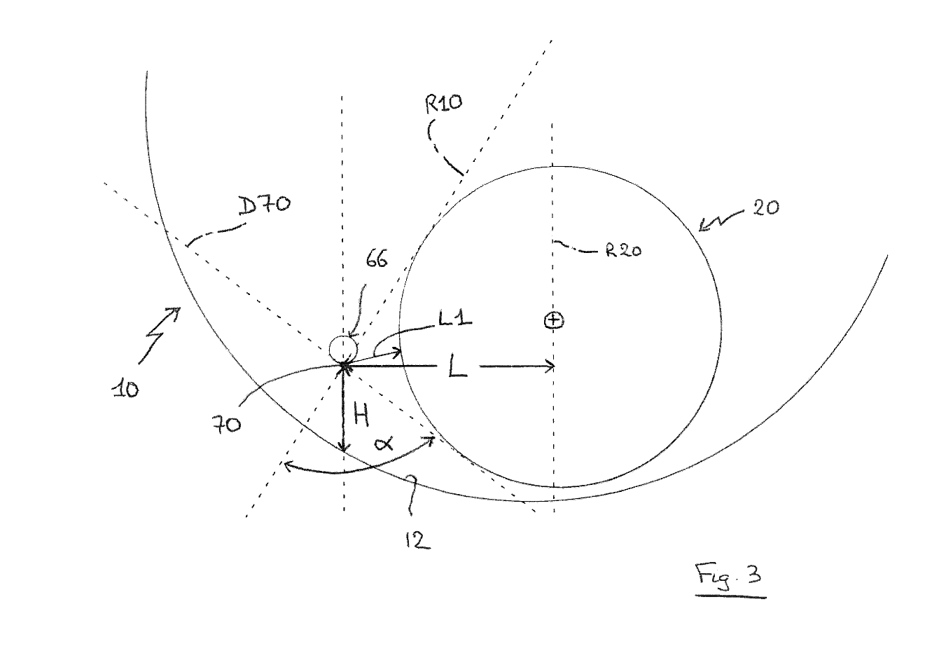

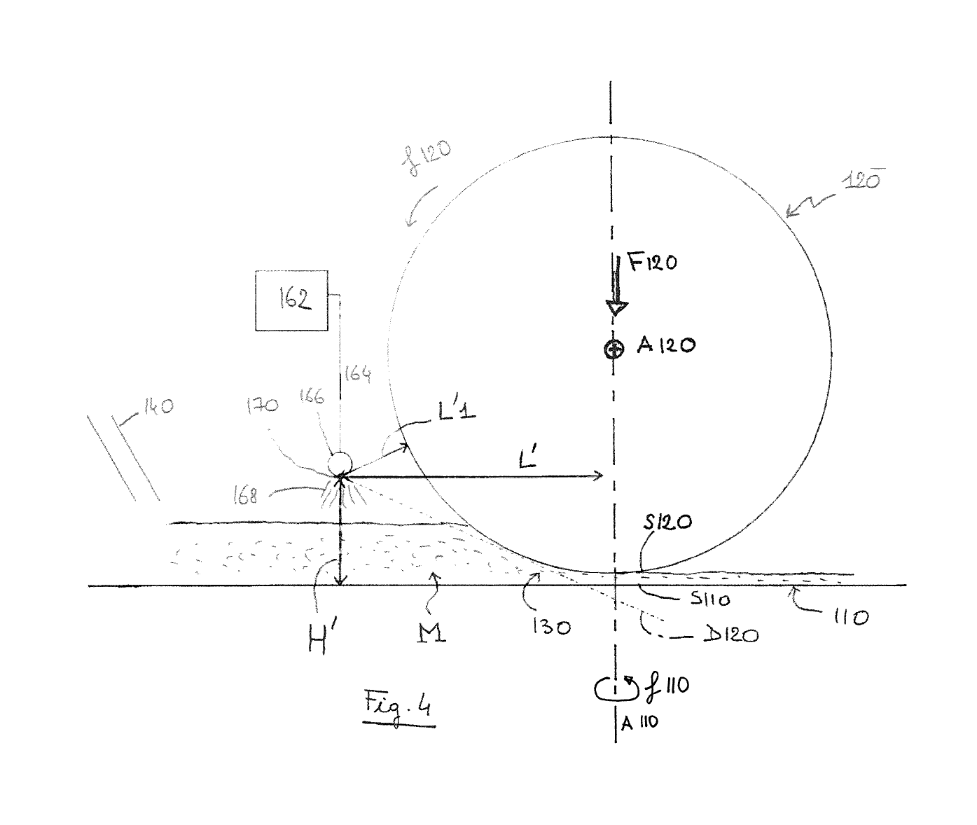

FIG. 3 represents a larger scale front view illustrating one part of the grinding unit in FIG. 1;

FIG. 4 represents a side view of a grinding unit according to a second embodiment of the invention; and

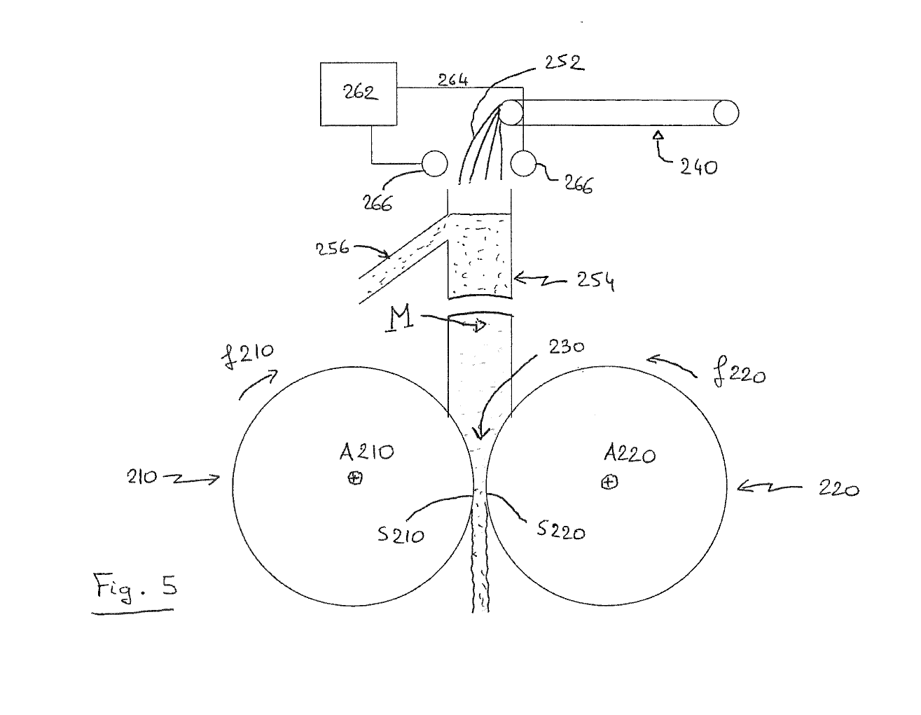

FIG. 5 represents a side view of a grinding unit according to a third embodiment of the invention.

The grinding unit according to the invention, illustrated in FIGS. 1 to 3, comprises a horizontal mill, formed by a ring 10 and a roller 20. These mechanical elements, known per se, are for example of the type described in EP 0 486 371. They are briefly described in the following section.

The ring 10, which is attached to a non-represented shell, is mounted on an axis A10 which is substantially horizontal, by means of non-represented motorized means. The inside wall of this ring delimits a track 12, which is circular in shape from a front view of the ring.

The roller 20, which is adapted to roll on the track 12 during the rotation of the ring 10, is mounted on a non-represented shaft, which is parallel to the axis A10. The roller 20 can turn freely around the shaft. Furthermore, non-represented mechanical means exert a force F20 on the roller to press the roller against the track. These pressing means, known per se, comprise for example springs or hydraulic jacks used with a hydro pneumatic system.

The surfaces facing each other, S10 and S20, are respectively parts of the ring and the roller. They define the grinding zone 30, through which a bed of material M to be ground is compressed, as described below. The inlet to this zone, which is noted 32, corresponds to the beginning of the compression phase of the bed of material, which is to say the reduction of the thickness of this bed of material. The roll gap of this zone, which is noted 34, corresponds to the smallest distance separating the two surfaces S10 and S20.

The unit also comprises feeding means 40 of material to be ground as well as evacuation means 50 of the ground material. These mechanical elements, of any suitable type, are well known per se, therefore they are represented as a diagram and are not described in further detail.

Finally, the unit is equipped with addition means 60, of oil to the bed of material, which is more particularly visible in FIG. 2. In the illustrated example these addition means comprise a reservoir of oil 62, connected via respective lines 64 to one or more nozzles 66. As illustrated in FIG. 2, the nozzles are regularly positioned over the width of the bed, which is to say in a transverse direction relative to the forward-moving direction of the bed. These nozzles 66 make it possible to advantageously spray droplets 68 of oil on the bed of material. These droplets have a diameter less than 200 micrometres, typically from 50 to 100 micrometres.

In reference to FIG. 3, R20 is defined as the radius of the roller 20, which is positioned vertically, and 70 is the distribution point of the droplets, which is to say the outlet of each nozzle 66. L is the distance which horizontally separates the distribution point 70 from the radius R20. Advantageously, the distance L is from 800 to 1500 millimetres, preferably from 1000 to 1300 millimetres.

Furthermore, L1 is the shortest distance separating this distribution point 70 from the external surface of the roller 20. Advantageously, the distance L1 is from 50 to 500 millimetres, preferably from 100 to 300 millimetres.

Finally, H is the distance which vertically separates the distribution point 70 from the track 12. Advantageously, the distance H is less than 500 millimetres, preferably from 100 to 500 millimetres, more preferably from 200 to 400 millimetres.

Implementation of the grinding unit in FIGS. 1 to 3 will now be described. The components of the hydraulic binder are fed onto the surface of the track in a known manner, via feeding means 40. Simultaneously, the ring 10 rotates according to the direction indicated by the arrow f10, whilst pressing means exert a force F20 to press the roller 20 against the track 12.

The components advance towards the grinding zone 30 according to the direction indicated by the arrow f1, and form a bed of material M. Droplets 68 of oil are sprayed via the nozzles 66, once the material arrives in front of these nozzles.

In the illustrated example, the oil is sprayed perpendicular to the forward-moving direction of the bed. However, this spray can be carried out within an angle α, illustrated in FIG. 3. This angle α is defined on one hand by the radius R10 of the track 12 passing through the distribution point 70, and on the other hand by the straight line D70 which is the tangent of the roller 20 passing through the distribution point 70. The angle a is preferably from 60 to 120°.

The quantity of added oil is delivered and controlled by any suitable means. For example, a spray of a pre-defined quantity may be released according to a pre-defined frequency. Adjustments can also be determined according to certain parameters, for example, the flow or the nature of the material to be ground. Typically, the quantity of oil added is from 0.2 to 1.5%, preferably from 0.5 to 1%, by weight of material fed by the feeding means 40.

Classically, during the passage of the components through the grinding zone 30, the components are ground and the thickness of the bed decreases. The ground components are then extracted according to the direction indicated by the arrow f2, via the evacuation means 50. These components then form the final hydraulic binder, optionally subject to one or more supplementary known treatment steps.

FIG. 4 illustrates a second embodiment of the invention. In FIG. 4, the mechanical elements are similar to those in FIGS. 1 and 2 and are given the same reference numbers increased by 100.

The grinding unit in FIG. 4 comprises a vertical mill, formed by a table 110 and one or more rollers, only one of which 120 is illustrated in this figure. The table 110 is mounted on a substantially vertical axis A110. The table 110 is adapted to rotate around the axis A110. The roller 120 is mounted on a substantially horizontal axis A120. The roller 120 is adapted to rotate around the axis A120. Furthermore, non-represented mechanical means, of known type, exert a force F120 on the roller 120 to press it against the table.

The surfaces facing each other, S110 and S120, are respectively parts of the table and a part of each roller; they delimit the grinding zone 130 through which the bed of material M to be ground is compressed. The unit also comprises feeding means 140 of material to be ground as well as evacuation means of the ground material, not represented and which are similar to the evacuation means 50 represented in FIG. 1.

Finally, the unit is equipped with addition means of oil to the bed of material. In the illustrated example, these addition means comprise a reservoir of oil 162 connected to one or more nozzles, only one of which 166 is illustrated, via respective lines, only one of which 164 is illustrated. These nozzles make it possible to spray droplets 168 of oil on the bed of material upstream of the inlet to the grinding zone.

The references L′ and L′1 are given to FIG. 4, which are defined as L and L1 in FIGS. 1 and 2, and reference H′, corresponds to the distance which vertically separates the distribution point 170 from the table 110. L′, L′1 and H′ have values within the same ranges as those defined herein above for L, L1 and H respectively.

When the grinding unit is in operation, the components of the hydraulic binder are introduced in a known manner to the centre of the table 110, via feeding means 140, and the table 110 rotates around its axis, according to the direction indicated by the arrow f110. The effect of centrifugal force pushes the components in a radial direction towards the external sides of the table 110.

A bed of material M is then formed, on which droplets of oil 168 are sprayed, via the nozzles 166. This spraying is carried out in a similar manner to what has been described with reference to FIGS. 1 to 3. The thickness of the bed of material decreases during its passage through the grinding zone 130, by the rotating effect f120 of the roller 120 associated with the pressing force F120. The ground components are then extracted, from the external side of the table via the evacuation means not represented in FIG. 4.

FIG. 5 illustrates a third embodiment of the invention. In FIG. 5, the mechanical elements are similar to those in FIGS. 1 to 3 and are given the same reference numbers, increased by 200.

The grinding unit in FIG. 5 comprises a roller press type of mill, formed by two rollers 210 and 220 mounted on respective, parallel and horizontal axes A210 and A220. The two rollers 210 and 220 are adapted to rotate around their respective axes A210 and A220, in opposite directions, represented by the direction indicated by the arrows f120 and f220. Furthermore, non-represented mechanical means typically exert a force to mutually bring these rollers 210 and 220 closer to each other. The surfaces of the rollers 210 and 220 facing each other, S210 and S220, delimit the grinding zone 230, through which the bed of material to be ground M is compressed.

The unit also comprises feeding means 240 of material to be ground as well as non-represented evacuation means of the ground material. In the illustrated example, the feeding means 240 are formed by a conveyor belt, which discharges a flow 252 of material to be ground into to a column 254, known per se, to form a bed of material M. An overflow pipe 256 typically maintains this bed of material at a pre-defined height.

Finally, the unit is equipped with addition means of oil to the bed of material. In the illustrated example, these addition means comprise a reservoir of oil 262 connected to one or more nozzles 266 via respective lines 264. These nozzles 266 make it possible to spray droplets of oil on the flow 252 of material upstream of the inlet to the grinding zone 230. Advantageously, the nozzles 266 are placed on each side of the flow of material 252 in order to spray the oil on all of the material. The thickness of the bed of material decreases during its passage through the grinding zone 230, by the rotating effect of the rollers 210 and 220. The ground components are then extracted, via not represented evacuation means.

The following non-restrictive example illustrates an implementation of the invention.

### EXAMPLE

Water was compared with a stabilizer according to the present invention within the scope of successive tests. Each test was carried out in a mill commercialised by FCB, of the Horomill® type. This mill, conforming to the mill illustrated in FIG. 1, has a track 12 with a diameter of 350 millimetres.

### Example According to the Technical State of the Art

Test 1 was carried out in the conditions described below. A CEM I 52.5 N cement was ground. The Blaine specific surface for this CEMI 52.5 cement was 3500 cm²/g. The particle size distribution was the following:

2.5% by volume of the particles of this cement passed through a 10-micrometre sieve,

15.5% by volume of the particles of this cement passed through a 50-micrometre sieve, and

42.6% by volume of the particles of this cement passed through a 90-micrometre sieve.

This CEMI 52.5N cement was fed at a flow rate of 20 kg/h. The pressure of the roller (see force F20 in FIG. 1) was 65 bars.

The set objective of the test was to grind the cement to the finest possible particle size distribution. With this aim, water was added at a flow rate of 300 ml/h. The maximum Blaine specific surface value obtained was 5949 cm²/g. It was not possible to exceed a Blaine specific surface of 5949 cm²/g, because the grinding unit presented operating instability.

### Example According to the Invention

Test 2 was carried out in the same mill, with the same component to be ground, and at an identical pressure.

The set objective of the test was to grind the cement to the finest possible particle size distribution. With this aim, mineral oil, commercialised by MOBIL, with the reference 600XP680, was added at a flow rate of 300 ml/h. During the test a Blaine specific surface value of 6000 cm²/g was obtained. Improved stability of the bed was observed and the flow rate of the treated material increased, until reaching a value of 30 kg/h.

Therefore, the use of oil, in particular a mineral oil as a grinding agent makes it possible to increase the efficiency of a compressive mill. It is thus possible, in similar operating conditions, to obtain greater grinding finenesses than those obtained using water as a grinding agent, and also increase the flow rate of the treated material.

1. A compression grinding process of at least one component of a hydraulic binder, the process comprising:
compressing a bed of material formed by the at least one component in a grinding zone, and
adding oil to the bed of material upstream of an inlet to the grinding zone.

2. The process according to claim 1, comprising adding a mineral oil to the bed of material.

3. The process according to claim 1, wherein the quantity of oil added to the bed of material is from 0.1 to 1.5%, percentage by mass relative to the mass of the at least one component to be ground.

4. The process according to claim 1, wherein the oil is sprayed on the bed of material.

5. The process according to claim 1, wherein the oil is added in several zones, which are positioned on one or more transverse axes relative to a forward-moving direction of the bed of material.

6. A process for production of a hydraulic binder comprising carrying out a compression grinding process according to claim 1.

7. A hydraulic binder produced according to the process of claim 6, said binder comprising 0.1 to 1.5% by mass of oil relative to the mass of binder.

8. A compression grinding unit of at least one component of a hydraulic binder, comprising:
a mill comprising two complementary grinding units, delimiting a grinding zone, through which passes a bed of material, formed by the at least one component;
a component supply configured to supply the at least one component to be ground into the grinding zone;
an evacuation system configured to evacuate the ground at least one component from the grinding zone;
an oil supply configured to supply oil and located between the component supply and the grinding zone.

9. A production installation of a hydraulic binder comprising a grinding unit according to claim 8.

10. A method comprising adding oil as a stabilizer in a compression grinding unit according to claim 8.
